(19) United States
(12) Patent Application Publication
(10) Pub. No.: US 2026/0201936 A1
(43) Pub. Date: Jul. 16, 2026

(54) RESERVOIR SHOCK ABSORBER

(71) Applicant: Douglas Hunter Powell, Austin, TX (US)

(72) Inventor: Douglas Hunter Powell, Austin, TX (US)

(21) Appl. No.: 19/213,830

(22) Filed: May 20, 2025

Related U.S. Application Data
(60) Provisional application No. 63/743,954, filed on Jan. 10, 2025.

(51) Int. Cl. F16F 9/348

(52) U.S. Cl. CPC F16F 9/3481

(57) ABSTRACT

A piston valve assembly for a reservoir shock absorber, the piston valve assembly includes a piston. The piston includes a first side and a second side, wherein the second side is opposite the first side. The piston also includes one or more compression ports and one or more rebound ports, each passing from the first side to the second side. The piston valve assembly also includes a first washer on the first side, wherein the first washer covers all the one or more rebound ports on the first side and a first parabolic disk, the first parabolic disk in partial contact with the first washer. The piston valve assembly further includes a second washer on the second side, wherein the second washer covers all the one or more compression ports on the second side and a second parabolic disk, the second parabolic disk in partial contact with the second washer.

### CROSS-REFERENCE TO RELATED APPLICATIONS

This application claims the benefit of and priority to U.S. Provisional Patent Application Ser. No. 63/743,954 filed on Jan. 10, 2025, which application is incorporated herein by reference in its entirety.

### BACKGROUND OF THE INVENTION

Reservoir shock absorbers, also known as shocks with reservoirs, are an advanced type of shock absorber designed to improve performance and durability, especially in demanding conditions. Reservoir shock absorbers feature an additional chamber, called a reservoir, connected to the main shock body by a high-pressure hose or flow channel. This reservoir can be mounted separately or directly on the shock body.

Reservoir shock absorbers have a number of benefits that include:
Improved Heat Dissipation: The extra fluid volume in the reservoir helps dissipate heat more effectively, preventing shock fade during prolonged use.
Enhanced Damping Control: Reservoir shocks offer increased adjustability, allowing drivers to fine-tune their suspension to match specific driving conditions.
Durability: The robust construction and ability to withstand extreme conditions ensure a longer lifespan compared to traditional shocks.
Increased Travel: The gas chamber being moved to the reservoir body allows for more shaft travel in the main shock body.
Better Ride Quality: Lower operating pressures and temperatures mean better durability for internal components resulting in improved ride quality.

Reservoir shocks are particularly beneficial for off-road driving, heavy-duty applications, and situations where the suspension experiences frequent and violent impacts.

The reservoir contains high-pressure gas (usually nitrogen) separated from the shock fluid by a floating piston. This separation prevents the fluid from foaming, which can lead to inconsistent damping.

Many reservoir shocks allow for post installation adjustments to compression damping, giving drivers the ability to fine-tune shock performance for different terrains and driving conditions. However, most adjustments to compression and rebound damping are not made after installation, but instead are made internally during the assembly process via piston valve assembly shims in the main shock body, before vehicle installation.

Reservoir shocks are especially useful for vehicles frequently driven in harsh terrains, such as off-road racing trucks, rock crawlers, and adventure SUVs. The ability to handle intense impacts and maintain consistent performance makes them ideal for these applications. In addition, heavy-duty trucks, SUVs, and motorsport vehicles (such as rally cars, desert racers, motocross, etc.) use reservoir shocks as the provide improved stability and control.

In addition, main shock body rebound, and compression dampening is accomplished via shim stacks incorporated in the piston valve assembly. A shim stack is a component in shock absorbers, especially in high-performance and tunable shocks. It consists of multiple thin metal discs, called shims, stacked together as a part of the shock absorber. The shim stacks are part of the piston valve assembly that controls the flow of hydraulic fluid and thus dampening within the shock absorber. As the shock absorber compresses or rebounds, the shims flex and allow fluid to pass through the piston valve assembly at a controlled rate, which determines damping force. By changing the number, thickness, shape and arrangement of the shims, the damping characteristics can be tuned to match specific performance needs. Shim stacks allow for tuning of the shock absorber's performance to suit different terrains, driving styles, and vehicle setups. Nevertheless, shim stacks have drawbacks.

For example, shim stacks change the suspension performance characteristics in a step function manner. A shim is either present or not, which means that the difference between a shock with a particular shim in a particular location is binary or a step function. This is offset somewhat by the order shims assembled and their thickness; however, this cannot be entirely removed.

Further, this adjustment process is complex. It is as much an art as a skill because it is not a straightforward process. There are few people who can adjust the performance of a shim stack and obtain the desired performance.

Accordingly, there is a need in the art for a reservoir shock absorber that allows for adjustment along a continuum rather than in a step function and provides a great consistency of performance. Further, there is a need in the art for the reservoir shock absorber with a method of easy assembly and disassembly when modifying compression damping adjustment.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a piston valve assembly for a reservoir shock absorber, the piston valve assembly includes a piston. The piston includes a first side and a second side, wherein the second side is opposite the first side. The piston also includes one or more compression ports passing from the first side to the second side and one or more rebound ports passing from the first side to the second side. The piston valve assembly also includes a first washer on the first side, wherein the first washer covers all of the one or more rebound ports on the first side and a first parabolic disk, wherein the first parabolic disk is in partial contact with the first washer. The piston valve assembly further includes a second washer on the second side, wherein the second washer covers all of the one or more compression ports on the second side and a second parabolic disk, wherein the second parabolic disk is in partial contact with the second washer.

Another example embodiment includes a main body for a reservoir shock absorber. The main body includes a primary chamber, the primary chamber configured to contain shock fluid and a piston valve assembly within the primary chamber. The piston valve assembly includes a piston. The piston includes a first side and a second side, wherein the second side is opposite the first side. The piston also includes one or more compression ports passing from the first side to the second side and one or more rebound ports passing from the first side to the second side. The piston further includes a seal on the piston, the seal configured to create a seal between the piston and the primary chamber. The piston valve assembly also includes a first washer on the first side, wherein the first washer covers all of the one or more rebound ports on the first side and a first parabolic disk, wherein the first parabolic disk is in partial contact with the first washer. The piston valve assembly further includes a second washer on the second side, wherein the second washer covers all of the one or more compression ports on the second side and a second parabolic disk, wherein the second parabolic disk is in partial contact with the second washer. The main body also includes a shaft. At least a first portion of the shaft passes through each of the piston, first washer, second washer, first parabolic disk and second parabolic disk and at least a second portion of the shaft passes out of the primary chamber. The main body further includes a fastener, wherein the fastener attaches to the shaft on the first portion, securing each of the piston, first washer, second washer, first parabolic disk and second parabolic disk.

Another example embodiment includes a reservoir shock absorber. The reservoir shock absorber including a main body for a reservoir shock absorber. The main body includes a primary chamber, the primary chamber configured to contain shock fluid and a piston valve assembly within the primary chamber. The piston valve assembly includes a piston. The piston includes a first side and a second side, wherein the second side is opposite the first side. The piston also includes one or more compression ports passing from the first side to the second side and one or more rebound ports passing from the first side to the second side. The piston further includes a seal on the piston, the seal configured to create a seal between the piston and the primary chamber. The piston valve assembly also includes a first washer on the first side, wherein the first washer covers all of the one or more rebound ports on the first side and a first parabolic disk, wherein the first parabolic disk is in partial contact with the first washer. The piston valve assembly further includes a second washer on the second side, wherein the second washer covers all of the one or more compression ports on the second side and a second parabolic disk, wherein the second parabolic disk is in partial contact with the second washer. The main body also includes a shaft. At least a first portion of the shaft passes through each of the piston, first washer, second washer, first parabolic disk and second parabolic disk and at least a second portion of the shaft passes out of the primary chamber. The main body further includes a fastener, wherein the fastener attaches to the shaft on the first portion, securing each of the piston, first washer, second washer, first parabolic disk and second parabolic disk. The main body additionally includes a fluid port, wherein the fluid port is configured to allow shock fluid to flow into and out of the primary chamber. The reservoir shock absorber further includes a first mount attached to the primary chamber, wherein the first mount is configured to attach to a frame of a vehicle and a second mount attached to the second portion of the shaft, wherein the second mount is configured to attach to an axle of a vehicle. The reservoir shock absorber additionally includes a hose, wherein the hose is attached to the fluid port of the main body and a reservoir. The reservoir is configured to contain shock fluid and a gas and a fluid port. The fluid port is configured to allow shock fluid to flow into and out of the reservoir and the hose is attached to the fluid port of the reservoir.

These and other objects and features of the present invention will become more fully apparent from the following description and appended claims or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a main body of a novel type or reservoir shock absorber;

FIG. 2A illustrates a cross-sectional perspective view of an example of a piston valve assembly at rest;

FIG. 2B illustrates a cross-sectional side view of an example of a piston valve assembly at rest;

FIG. 2C illustrates a cross-sectional perspective view of an example of a piston valve assembly during compression;

FIG. 2D illustrates a cross-sectional side view of an example of a piston valve assembly during compression;

FIG. 2E illustrates a cross-sectional perspective view of an example of a piston valve assembly during rebound;

FIG. 2F illustrates a cross-sectional side view of an example of a piston valve assembly during rebound;

FIG. 3A illustrates a top perspective view of the example of a piston;

FIG. 3B illustrates a bottom perspective view of the example of a piston;

FIG. 4 illustrates an example of a reservoir for a reservoir shock absorber;

FIG. 5A illustrates a cross-sectional perspective view of an example of a regulator at rest;

FIG. 5B illustrates a cross-sectional side view of an example of a regulator at rest;

FIG. 5C illustrates a cross-sectional perspective view of an example of a regulator during extreme compression;

FIG. 5D illustrates a cross-sectional side view of an example of a regulator during extreme compression;

FIG. 5E illustrates a cross-sectional perspective view of an example of a regulator during rebound; and

FIG. 5F illustrates a cross-sectional side view of an example of a regulator during rebound.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

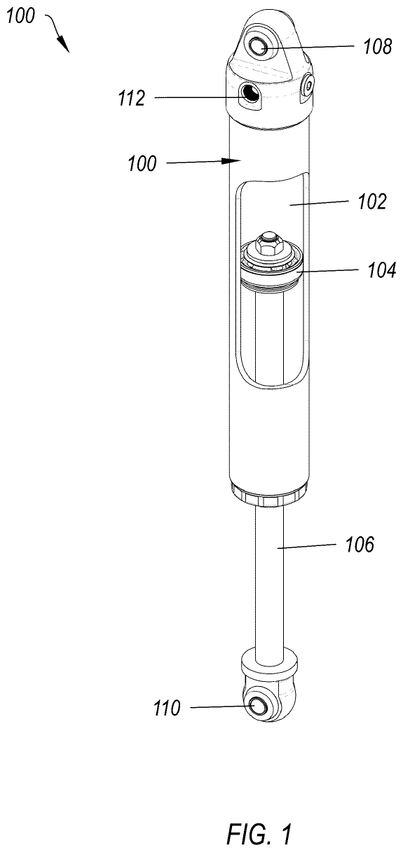

FIG. 1 illustrates a main body 100 of a novel type or reservoir shock absorber. The novel shock absorber allows for adjustment along a continuum rather than in a step function. In addition, the novel shock absorber allows for post-installation adjustment.

FIG. 1 shows that the main body 100 can include a primary chamber 102. Reservoir shocks consist of two main chambers: the primary chamber 102 (inside the main body 100) and the remote reservoir. The primary chamber 102 contains shock fluid (usually oil) and the remote reservoir contains shock fluid and a gas (usually nitrogen). The primary chamber 102 and the remote reservoir are connected to one another through a hose or other mechanism that allows fluid flow between the primary chamber and the remote reservoir, as described below. The primary chamber 102 handles the initial damping during compression and rebound.

FIG. 1 also shows that the main body 100 can include a piston valve assembly 104. The piston valve assembly 104 moves through the shock fluid withing the primary chamber 102. This movement is impeded by the shock fluid. I.e., there is a resistance within the shock fluid to any movement of the piston valve assembly 104. The resistance of the shock fluid to movement of the piston valve assembly 104 can be adjusted by characteristics of the piston valve assembly 104 which in turn changes the performance of the reservoir shock absorber.

FIG. 1 further shows that the main body 100 can include a shaft 106. The shaft 106 is attached to the piston valve assembly 104 and extends at least partially out of the primary chamber 102. The shaft 106 is typically made from high-strength steel or other durable materials that can withstand significant forces and wear over time. The shaft 106 can include a surface finish, such as chrome, to provide a smooth, corrosion-resistant surface that reduces friction and wear as it moves in and out of the main body 100. The diameter of the shaft 106 can vary depending on the design and application of the shock absorber. Generally, a thicker shaft 106 can handle greater loads and provide more stability. The shaft's 106 smooth operation and durability are crucial for maintaining a comfortable ride and stable handling in a vehicle.

FIG. 1 additionally shows that the main body 100 can include a first mount 108. The first mount 108 allows the main body 100 to be attached to the frame of a vehicle. The first mount 108 is stable, meaning that it does not move along the frame but does allow some rotational movement of the main body 100 around the first mount 108.

FIG. 1 moreover shows that the shaft 106 can include a second mount 110. The second mount 110 is typically attached to the vehicle's axle, allowing it to transfer the forces and movements from the road through the reservoir shock absorber to the frame of the vehicle.

FIG. 1 also shows that the main body 100 can include a fluid port 112. The fluid port 112 allows shock fluid to flow into and out of primary chamber 102. I.e., shock fluid flows out of the primary chamber 102 through the fluid port 112 during compression and into the primary chamber 102 through the fluid port 112 during rebound.

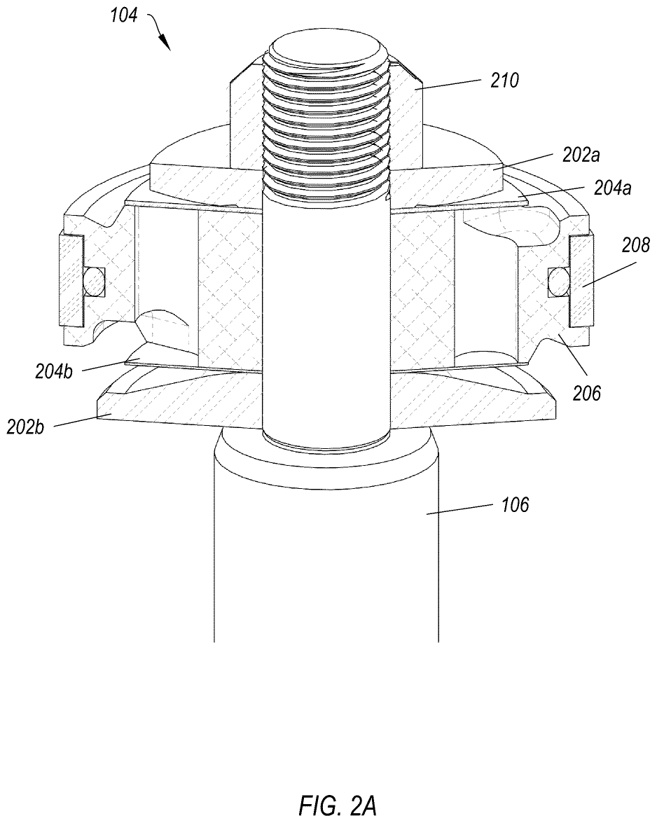

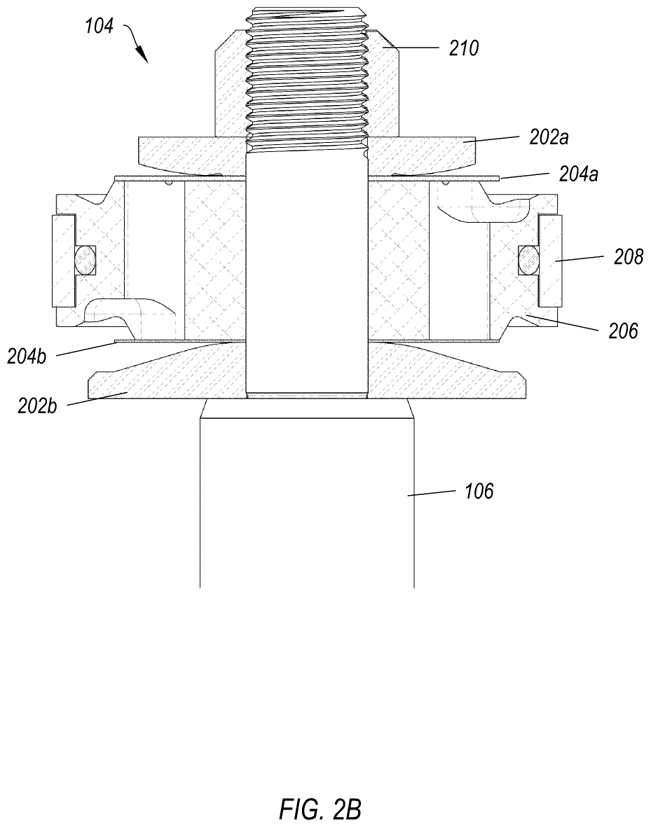

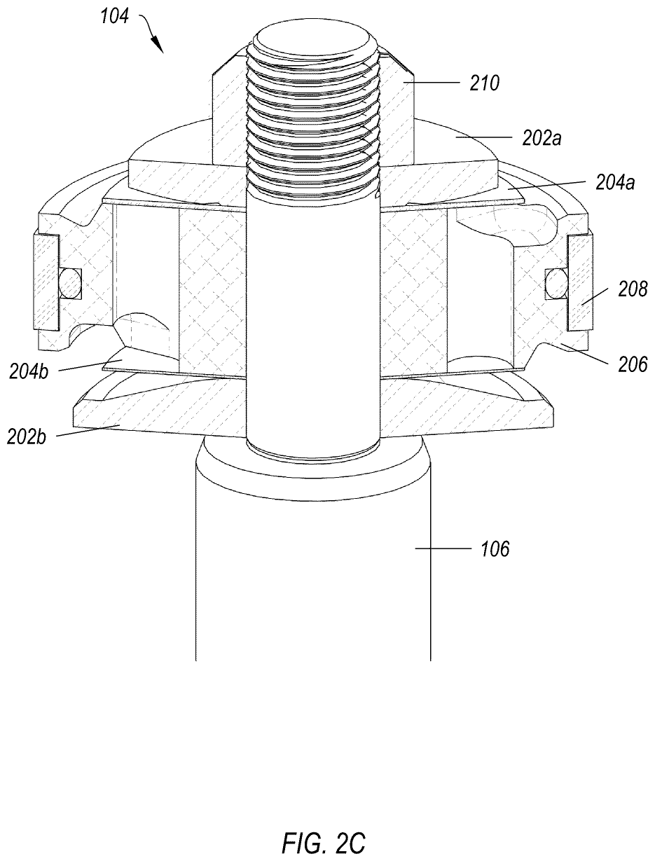

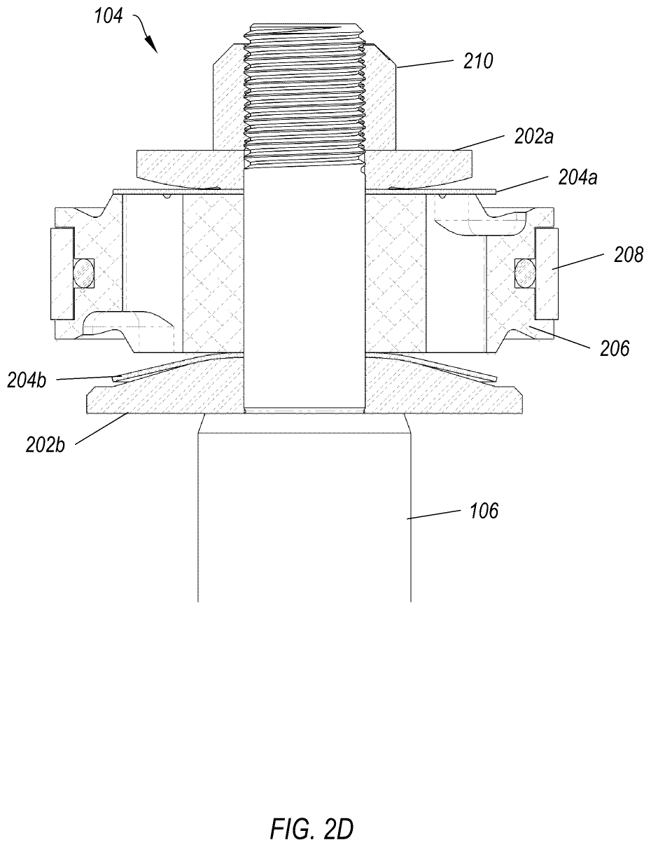

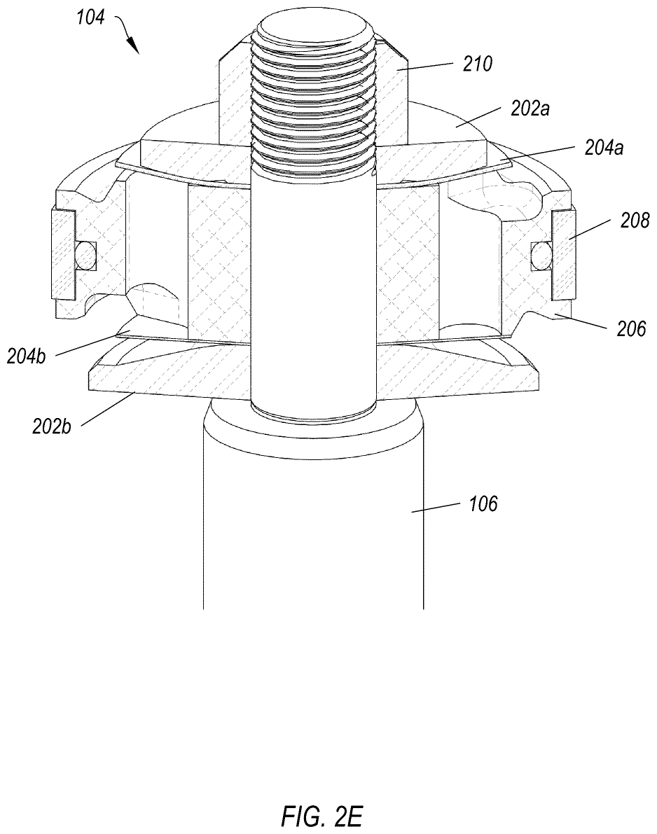

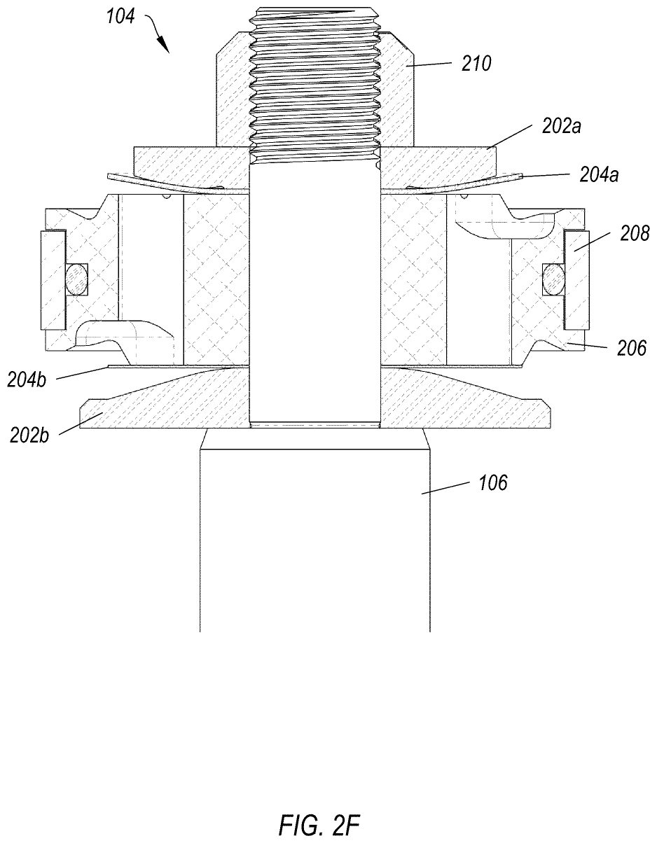

FIGS. 2A-2F (collectively “FIG. 2”) illustrate an example of a piston valve assembly 104. FIG. 2A illustrates a cross-sectional perspective view of an example of a piston valve assembly 104 at rest; FIG. 2B illustrates a cross-sectional side view of an example of a piston valve assembly 104 at rest; FIG. 2C illustrates a cross-sectional perspective view of an example of a piston valve assembly 104 during compression; FIG. 2D illustrates a cross-sectional side view of an example of a piston valve assembly 104 during compression; FIG. 2E illustrates a cross-sectional perspective view of an example of a piston valve assembly 104 during rebound; and FIG. 2F illustrates a cross-sectional side view of an example of a piston valve assembly 104 during rebound. The piston valve assembly 104 includes a number of unique features which allows the user to adjust the performance of the reservoir shock absorber.

FIG. 2 shows that the piston valve assembly 104 is attached to the shaft 106. A portion of the shaft 106 passes through the piston valve assembly 104. This makes the shaft 106 and the piston valve assembly 104 act as a single unit. Thus, as the vehicle goes over terrain that either would lengthen or shorten the distance between the frame and the axle the shaft 106 and piston valve assembly 104 try to move through the shock fluid. The resistance to that movement causes a dampening effect on the movement. The resistance can be adjusted by a combination of factors, such as the movement of the shock fluid through the piston valve assembly 104, the viscosity of the shock fluid, etc.

FIG. 2 also shows that the piston valve assembly 104 can include a first parabolic disk 202a and a second parabolic disk 202b (collectively “parabolic disks 202”). The parabolic disks 202 include shaped discs that can be used to control the flow of shock fluid through the piston valve assembly 104. The parabolic disks 202 create a different response versus conventional shock absorbers because the parabolic disks 202 can provide different resistances based on different forces (e.g., double the force doesn't necessarily double the resistance, as described below). The shape of the first parabolic disk 202a does not have to be, but may be, the same shape as the second parabolic disk 202b.

FIG. 2 further shows that the piston valve assembly 104 includes a first washer 204a and a second washer 204b (collectively “washers 204”). The first washer 204a flexes against the first parabolic disk 202a during rebound and the second washer 204b flexes against the second parabolic disk 202b during compression. The washers 204 are in partial contact with the parabolic disks 202, with the amount of contract changing depending on the fluid pressure. For example, during compression (as shown in FIGS. 2C and 2D) fluid pressure tries to flow downward (as shown in FIG. 2) and the second washers 204b flexes, pressing onto the second parabolic disk 202b. As the pressure increases the amount of contact increases and the portion of the second washer 204a in contact with the second parabolic disk 202b matches the shape of the parabolic disk 202b, with the portion not in contact with the parabolic disk 202b being flat or straight. However, the first washer 204a is pushed away from the first parabolic disk 202a. The contours of the second parabolic disk 202b allow variable resistance during compression depending on force-loads allowing an extremely refined tune compared to a shim stack. Thus, the parabolic disks 202 and washers 204 provide precision fluid flow in a minimal sized piston stack.

Parabolic disks 202, in contrast, can provide infinite control within the desired range. I.e., the parabolic disks 202 can be changed to provide far more dependable control of shock absorber characteristics. In particular, the parabolic disks 202 can be used to provide any desired performance curve. Further, parabolic disks 202 can be completely customized to the desired application.

In addition, parabolic disks 202 remove a lot of complexity. They require far fewer parts and the parts are more durable, meaning that once a desired shock performance is determined, the shock follows the same compression pattern throughout its lifetime whereas shim stacks will deliver different performance over time as the shims undergo flex and relaxation. In addition, the tolerances of the shims are additive. For example, if the tolerance of each shim is 1/1000 of an inch ( 0.001 inches) but the shim stack includes seven shims, the overall tolerance of the stack is 7/1000 of an inch (0.007 inches) which is sufficient to affect performance. Parabolic valving requires only a single set of washers 204 which flex around the parabolic disks 202. Different parabolic disks 202 can be inserted for different performance characteristics, reducing the amount of adjustment that needs to be done by a user. I.e., the shape of parabolic disks 202 as shown in the figures is not limiting but should be considered just one example.

FIG. 2 additionally shows that the piston valve assembly 104 can include a piston 206. The piston 206 allows shock fluid to flow through the piston valve assembly 104 at a controlled rate. I.e., even if the piston valve assembly 104 was just the piston 206, there would be some resistance to the movement of the piston 206 through the shock fluid. The amount of flow through the piston 206 is discussed below.

FIG. 2 moreover shows that the piston valve assembly 104 can include a seal 208. The seal 208 prevents shock fluid from flowing around the piston valve assembly 104 and forces the fluid to flow through the piston 206 and past the parabolic disks 202 and washers 204. This means that the fluid flow is completely controlled by the shape of the parabolic disks 202, the thickness and flexibility of the washers 204 and the fluid flow through the piston 206, which makes it infinitely customizable. The seal 208 can include any desired material, such as rubber.

FIG. 2 also shows that the piston valve assembly 104 can include a fastener 210. The fastener 210 is placed on the shaft 106. In particular, a portion of the shaft 106 passes through a central opening in the parabolic disks 202, the washers 204 and the piston 206. The fastener 210 is threaded onto the shaft 106, holding the parabolic disks 202, the washers 204 and the piston 206 in place.

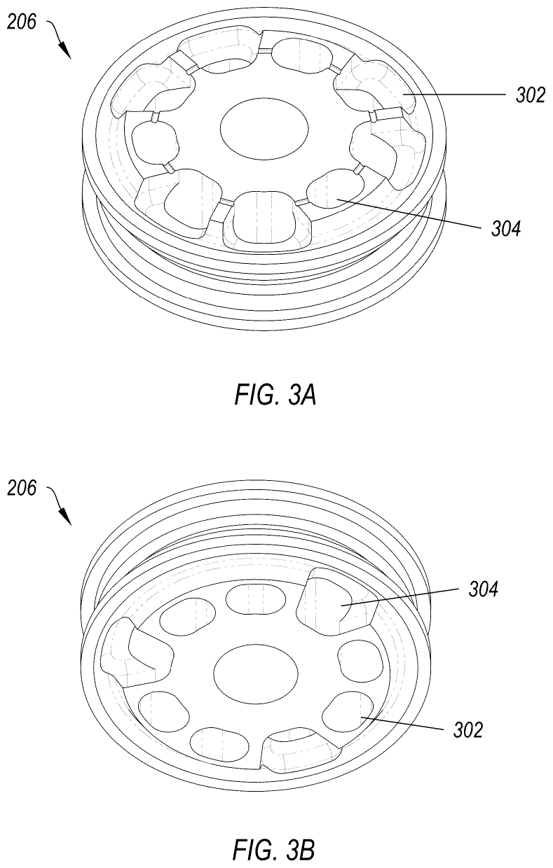

FIGS. 3A-3B (collectively “FIG. 3”) show an example of a piston 206. FIG. 3A illustrates a top perspective view of the example of a piston 206; and FIG. 3B illustrates a bottom perspective view of the example of a piston 206. The piston 206 helps control the flow of shock fluid through a shock absorber.

FIG. 3 shows that the piston 206 can include one or more compression ports 302. The compression ports 302 have fluid flow through them during a compression event moving the piston valve assembly of a reservoir shock absorber through the primary chamber (upward in FIG. 1). The compression ports 302 along with the second parabolic disk and second washer form a compression valve.

FIG. 3 also shows that the piston 206 can include one or more rebound ports 304. The rebound ports 304 have fluid flow through them during a rebound event moving the piston valve assembly of a reservoir shock absorber through the primary chamber (downward in FIG. 1). The rebound ports 304 along with the first parabolic disk and first washer form a rebound valve. Although the rebound ports 304 are similar in size and shape to the compression ports 302 in FIG. 3, they can be different to allow for different fluid flow during compression and rebound.

By way of example, the piston 206 a total of 9 ports to produce an even force-load to the washers—6 compression ports 302 and 3 rebound ports 304—that ensure longevity and optimal performance. However, one of skill in the art will appreciate that other ratios can be used. For example, there could be 8 compression ports 302 and 4 rebound ports 304. The 3-fold symmetry of the ports prevents torque from uneven flow through the compression ports 302 or rebound ports 304 but other symmetry could be used, such as 2-fold symmetry or 4-fold symmetry.

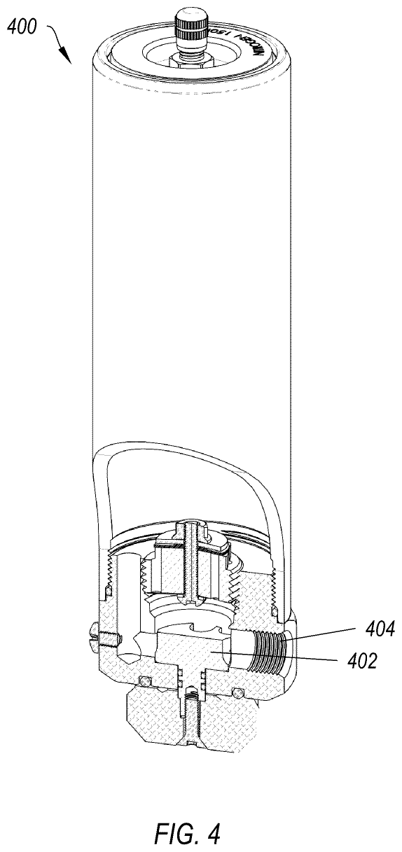

FIG. 4 illustrates an example of a reservoir 400 for a reservoir shock absorber. Unlike traditional shock absorbers, reservoir shock absorbers feature an additional reservoir 400 connected to the main shock body by a high-pressure hose. This reservoir 400 serves a crucial purpose, allowing for increased fluid capacity and improved heat dissipation. In particular, the primary chamber has only shock fluid. In contrast, the top of the reservoir 400 in FIG. 4 has a gas or a gas/fluid mixture and the bottom of the reservoir 400 has overflow fluid (this separation occurs naturally due to gravity). The extra fluid volume prevents overheating during prolonged and demanding driving conditions, ensuring consistent performance. Further, the reservoir 400 ensures that the shaft can travel the full length of the shock body because the gas chamber is not integral to the main shock body and inline with the shaft.

FIG. 4 shows that the reservoir 400 can include a regulator 402. The regulator 402 is a solid piston that controls fluid flow into and out of the reservoir 400. During compression, fluid flows into the fluid side of the reservoir and through the regulator 402. In particular, during compression the piston valve assembly moves through the fluid in the primary chamber. Because the fluid doesn't compress (or compresses very little) there is drag that resists the compression. I.e., the movement of the piston valve assembly creates a pressure differential. This is partially accommodated by the fluid flowing through the piston valve assembly (this fluid flow is controlled by the parabolic disks as described above) and partially accommodated by fluid flowing through the regulator 402. Likewise, the shaft now takes some of the volume within the primary chamber which changes the volume of the primary chamber available to hold the fluid. However, because the fluid doesn't compress it can create high pressures within the fluid. This extra pressure is “bled off” into the reservoir 400 where it flows through the regulator 402 and compresses the air side of the reservoir 400.

FIG. 4 also shows that the reservoir 400 can include a fluid port 404. The fluid port 404 is connected to the fluid port of the main body. In particular, there is a hose that connects the fluid port 404 and the fluid port of the main body. In general, the hose is not limiting of fluid flow as that is controlled by other components, including the regulator 402.

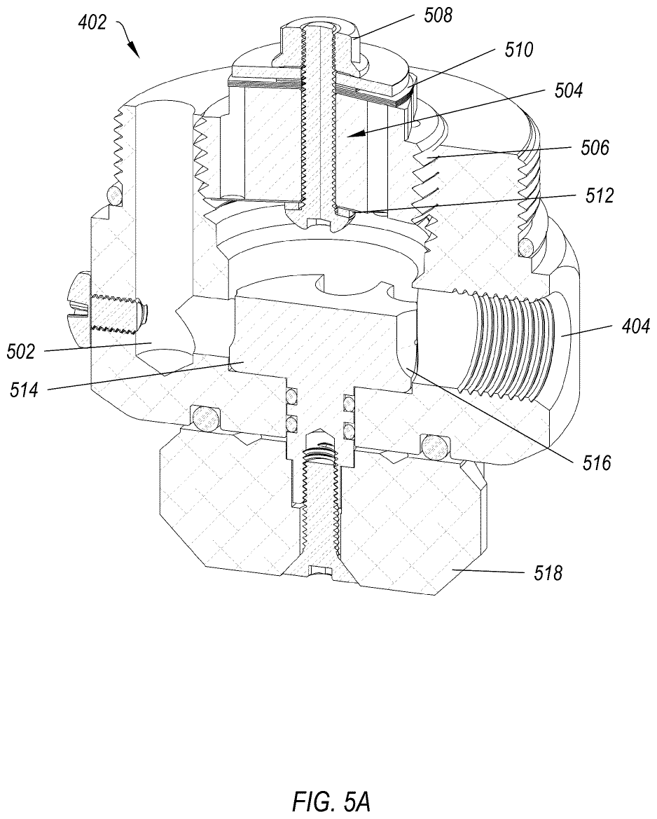

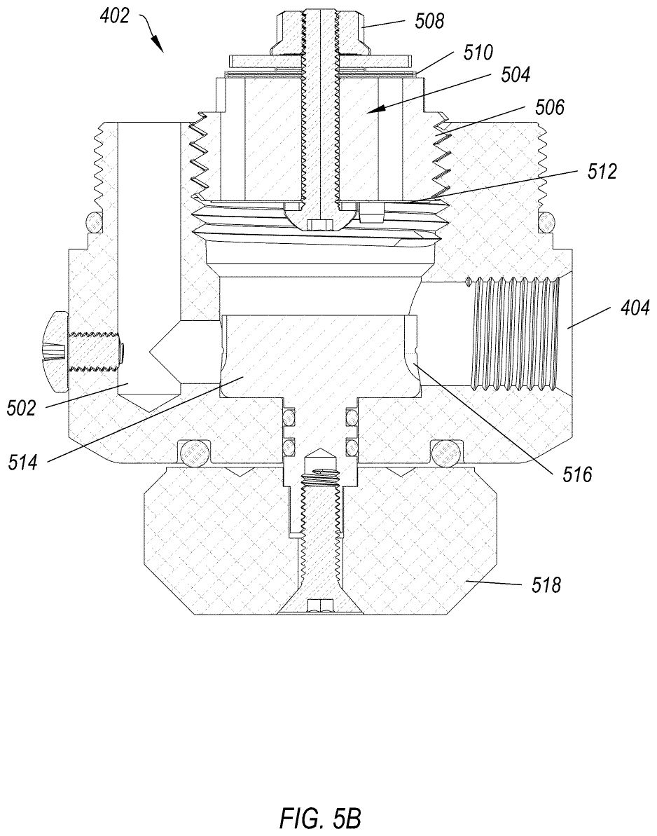

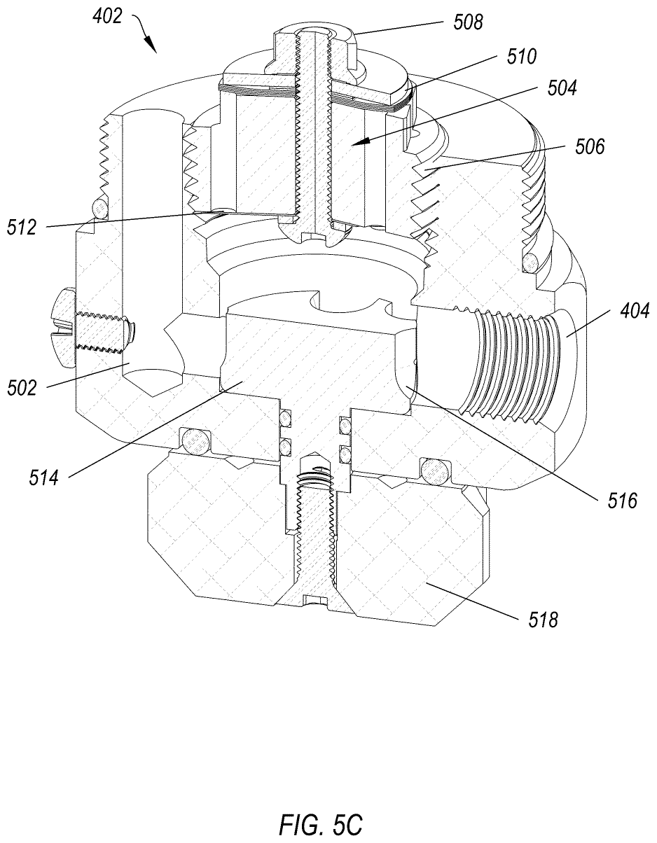

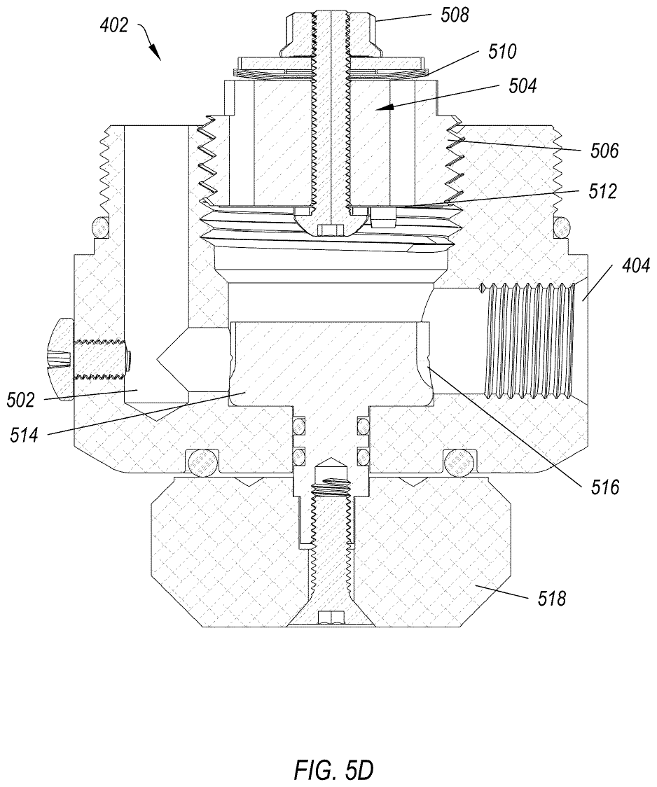

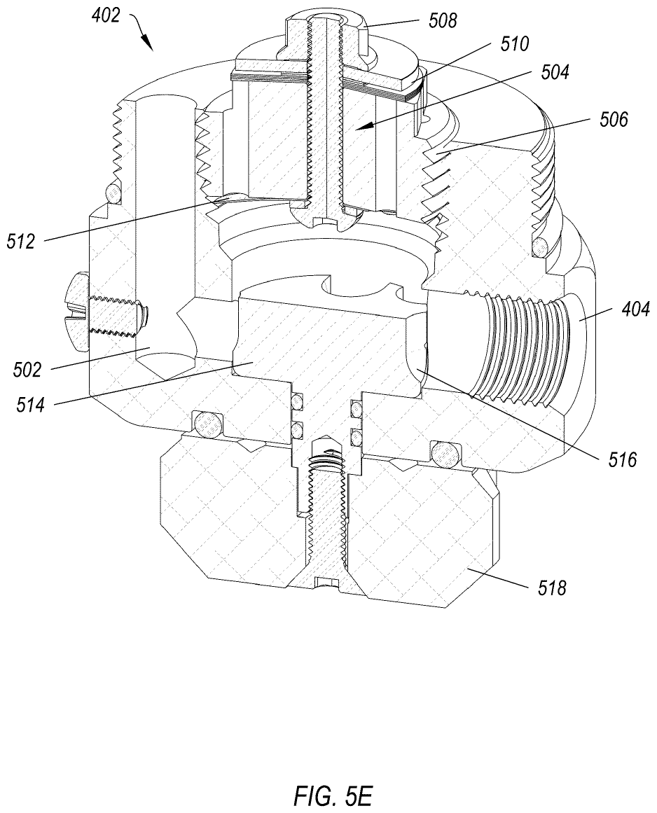

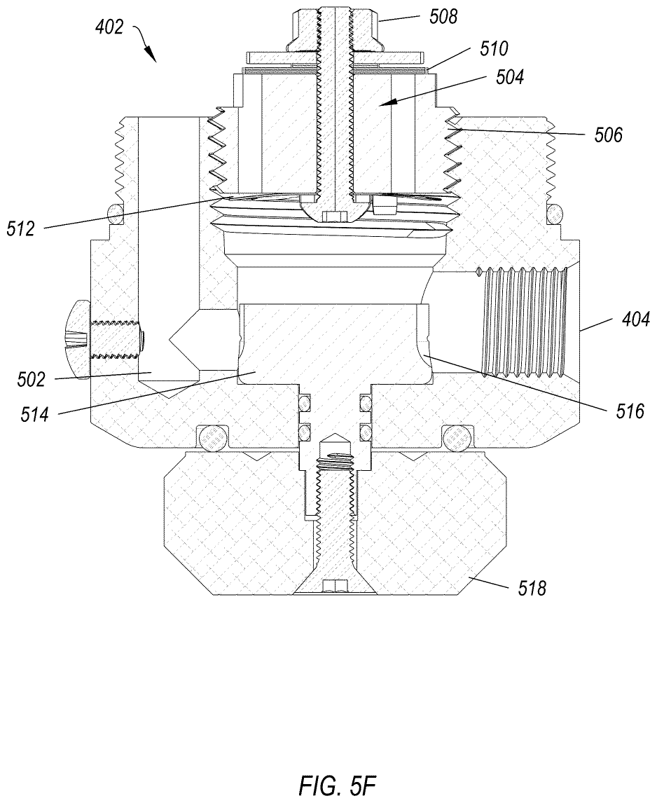

FIGS. 5A-5F (collectively “FIG. 5”) illustrate an example of a regulator 402. FIG. 5A illustrates a cross-sectional perspective view of an example of a regulator 402 at rest; FIG. 5B illustrates a cross-sectional side view of an example of a regulator 402 at rest; FIG. 5C illustrates a cross-sectional perspective view of an example of a regulator 402 during extreme compression; FIG. 5D illustrates a cross-sectional side view of an example of a regulator 402 during compression; FIG. 5E illustrates a cross-sectional perspective view of an example of a regulator 402 during rebound; and FIG. 5F illustrates a cross-sectional side view of an example of a regulator 402 during rebound. The regulator 402 controls the fluid flow into and out of the reservoir of a reservoir shock absorber. Fluid dynamics dictates that changes in path size, friction, direction, etc. all change the rate of fluid flow. Therefore, the regulator 402 can be used to change fluid flow between the reservoir and attached main shock body, which means it changes the performance characteristics of the shock absorber.

FIG. 5 shows that the regulator 402 can include a channel 502. The channel 502 is a path for fluid flow to and from the fluid port 404. I.e., the channel 502 is where the shock fluid moves into and out of the fluid port 404. The shape and length of the channel 502 can determine the dampening effect of the shock absorber, as discussed below.

FIG. 5 also shows that regulator 402 can include a valving unit 504. The valving unit 504 allows shock fluid to at least partially bypass the channel 502 under certain circumstances, such as rebound and extreme compression. For example, when an extreme compression condition achieves a pressure sufficient to potentially cause damage to the reservoir shock absorber, the valving unit 504 allows shock fluid to move without going through the channel 502 thus relieving the pressure from extreme compression.

FIG. 5 further shows that the valving unit 504 can include a tapered thread 506. A tapered thread 506 is a type of thread on pipes and fasteners that gradually decreases in diameter from one end to the other. This tapering allows for a tight mechanical engagement just makes it leak resistant, vibration resistant and loosening resistant) when the male and female parts are screwed together. In particular, the tapered thread 506 creates leak resistance but prevents loosening due to vibration.

Unlike straight threads, which maintain a constant diameter, tapered threads 506 have a slight conical shape. This design ensures that the threads compress tightly against each other, creating a seal. The tapered design allows for self-sealing. The tapered threads 506 form a tight, fluid-resistant joint.

The tapered thread 506 provides a number of advantages. The tight seal created by tapered threads 506 helps prevent leaks in fluid and gas systems. The tapered threads 506 are designed to withstand high pressure and vibration, making them durable and reliable. Tapered threads 506 are relatively easy to install, uninstall and reinstall and do not require additional sealing or fixation components like O-rings, c-clips or locking screws in many cases.

FIG. 5 additionally shows that the valving unit 504 can include a hex fastener 508 on the top (as shown in FIG. 5). The hex fastener 508 allows a user to tighten, loosen or remove the valving unit 504 within the reservoir. This allows a user to change or clean the valving unit 504, etc. I.e., because hex fasteners 508 are common, the hex fastener 508 means that the user has the ability to make changes as desired.

FIG. 5 moreover shows that the valving unit 504 can include a blow off shim stack 510. The blow off shim stack 510 is the mechanism that allows the valving unit 504 to prevent extreme pressure in the main shock body during a compression event, which could cause the main shock body. Under an extreme jolt to the shock absorber the blow off shim shack 510 will flex and relieve such pressure into the reservoir.

FIG. 5 further shows that the valving unit 504 can include a check valve 512. The check valve 512 acts as a butterfly valve which opens whenever a rebound event occurs but closes during a compression event. Typically, the check valve 512 includes a single shim that is thin (for example, it can be 0.005 inches thick) so that even a small amount of rebound pressure (which may be as low as 1-2 psi) will cause the check valve 512 to open and allow fluid flow out of the reservoir into the main shock body. I.e., the check valve 512 allows all fluid flow to bypass the channel 502 during rebound events.

FIG. 5 also shows that the regulator 402 can include a choke 514. The shock fluid flows into the fluid port 404, through the choke 514 and then through the channel 502 and valving unit 504 into the main body of the reservoir. Thus, the characteristics of the choke 514 can be used to create desired changes in the fluid flow.

FIG. 5 further shows that the choke 514 can include a series of apertures 516. The apertures 516 create distinct paths for the fluid flow. For example, large apertures 516 allow shock fluid to move quickly within the channel 502 and fluid port 404. I.e., an aperture 516 that is large enough means that the fluid flow is essentially unrestrained by the choke 514, which means that the dampening of the shock absorber is limited. In contrast, small apertures 516 mean that most of the fluid flow is controlled by the choke 514. I.e., an aperture that is small means that the fluid flow is highly restrained by the choke 514, which results in a high amount of dampening by the shock absorber.

FIG. 5 further shows that the regulator 402 can include a dial 518. The dial 518 can be used to change the fluid path through the choke 514. In particular, the dial 518 changes which aperture 516 are in the fluid path. I.e., the dial 518 puts different apertures 516, which changes flow resistance, in the path of the fluid flow, dictating how much pressure needs to be present before it moves from the shock body to the reservoir and vice versa. This allows a user to adjust shock performance by turning the dial 518. I.e., shock performance can be adjusted after the shock has been mounted, which is not present in other reservoir shock absorbers. So, for example, the shock can be adjusted when moving from paved roads to offroad settings.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A piston valve assembly for a reservoir shock absorber, the piston valve assembly comprising:
a piston including:
a first side;
a second side opposite the first side;
one or more rebound ports extending from the first side to the second side; and
one or more compression ports extending from the second side to the first side;
a washer stack comprising one or more washers, one of the one or more washers in the washer stack contacting the first side and covering at least a portion of at least one of the one or more compression ports; and
a parabolic disk having a contoured side, the contoured side of the parabolic disk being in partial contact with one of the one or more washers in the washer stack.

2. The piston valve assembly of claim 1 further comprising:
a second washer stack comprising one or more washers, one of the one or more washers in the second washer stack contacting the second side and covering at least a portion of at least one of the one or more rebound ports; and
a second parabolic disk having a contoured side, the contoured side of the second parabolic disk being in partial contact with one of the one or more washer in the second washer stack.

3. The piston valve assembly of claim 2, wherein the one or more compression ports have a larger opening on the first side such that the washers in the washer stack cannot cover all of the one or more compression ports on the first side.

4. The piston valve assembly of claim 3, wherein the one or more rebound ports have a larger opening on the second side such that the washers in the second washer stack cannot cover all of the one or more second ports on the second side.

5. The piston valve assembly of claim 2 wherein each of the piston, each of the washers in the washer stack, each of the washers in the second washer stack, the parabolic disk and the second parabolic disk include a central opening configured to receive a portion of a shaft of a shock absorber.

6. The piston valve assembly of claim 2, wherein the shape of the parabolic disk is the same as the shape of the second parabolic disk.

7. The piston valve assembly of claim 2, wherein the shape of the parabolic disk is different than the shape of the second parabolic disk.

8. The piston valve assembly of claim 1 further comprising a seal on the piston, the seal configured to prevent shock fluid leakage around the piston when placed in a shock absorber.

9. The piston valve assembly of claim 1, wherein the piston includes twice as many compression ports as rebound ports.

10. The piston valve assembly of claim 1, wherein the piston includes 3-fold symmetry.

11. The piston valve assembly of claim 1, wherein the piston includes six compression ports and three rebound ports.

12. The piston valve assembly of claim 1, wherein one of the one or more washers is circular.

13. The piston valve assembly of claim 1, wherein one of the one or more washers is non-circular.

14. A main body for a reservoir shock absorber, the main body comprising:
a primary chamber, the primary chamber configured to contain shock fluid;
a piston valve assembly within the primary chamber, the piston valve assembly including:
a piston including:
a first side;
a second side opposite the first side;
one or more rebound ports extending from the first side to the second side; and
one or more compression ports extending from the second side to the first side;
a seal on the piston, the seal configured to create a seal between the piston and the primary chamber;
a first washer stack comprising one or more washers, one of the one or more washers in the first washer stack contacting the first side and covering at least a portion of at least one of the one or more compression ports;
a first parabolic disk having a contoured side, the contoured side of the first parabolic disk being in partial contact with one of the one or more washers in the first washer stack;
a second washer stack comprising one or more washers, one of the one or more washers in the second washer stack contacting the second side and covering at least a portion of at least one of the one or more rebound ports; and
a shaft, wherein:
at least a first portion of the shaft passes through each of the piston, first washer, second washer, first parabolic disk and second parabolic disk; and
at least a second portion of the shaft passes out of the primary chamber; and
a fastener, wherein the fastener attaches to the shaft on the first portion, securing each of the piston, first washer, second washer, first parabolic disk and second parabolic disk.

15. The system of claim 14, wherein the washers in the first washer stack flexes under pressure.

16. The system of claim 14, wherein the washers in the second washer stack flexes under pressure.

17. The system of claim 14 further comprising a first mount attached to the primary chamber, wherein the first mount is configured to attach to a frame of a vehicle.

18. The system of claim 14 further comprising a second mount attached to the second portion of the shaft, wherein the second mount is configured to attach to an axle of a vehicle.

19. A reservoir shock absorber, the reservoir shock absorber comprising:
a main body, the main body including:
a primary chamber, the primary chamber configured to contain shock fluid;
a piston valve assembly within the primary chamber, the piston valve assembly including:
a piston including:
a first side;
a second side opposite the first side;
one or more rebound ports extending from the first side to the second side; and
one or more compression ports extending from the second side to the first side;
a seal on the piston, the seal configured to create a seal between the piston and the primary chamber;
a first washer stack comprising one or more washers, one of the one or more washers in the first washer stack contacting the first side and covering at least a portion of at least one of the one or more compression ports;
a first parabolic disk having a contoured side, the contoured side of the first parabolic disk being in partial contact with one of the one or more washers in the first washer stack;
a second washer stack comprising one or more washers, one of the one or more washers in the second washer stack contacting the second side and covering at least a portion of at least one of the one or more rebound ports; and
a shaft, wherein:
at least a first portion of the shaft passes through each of the piston, first washer, second washer, first parabolic disk and second parabolic disk; and
at least a second portion of the shaft passes out of the primary chamber; and
a fastener, wherein the fastener attaches to the shaft on the first portion, securing each of the piston, first washer, second washer, first parabolic disk and second parabolic disk
a fluid port, wherein the fluid port is configured to allow shock fluid to flow into and out of the primary chamber;
a first mount attached to the primary chamber, wherein the first mount is configured to attach to a frame of a vehicle;
a second mount attached to the second portion of the shaft, wherein the second mount is configured to attach to an axle of a vehicle;
a hose, wherein the hose is attached to the fluid port of the main body;
a reservoir, wherein the reservoir:
is configured to contain shock fluid and a gas; and
includes:
a fluid port, wherein:
the fluid port is configured to allow shock fluid to flow into and out of the reservoir; and
the hose is attached to the fluid port of the reservoir.

20. The system of claim 19, wherein the seal is rubber.
